(19) United States
(12) Patent Application Publication
(10) Pub. No.: US 2021/0214056 A1
(43) Pub. Date: Jul. 15, 2021

(54) FLOATABLE ARRAY READY SOLAR MODULE MOUNTING DEVICE, SYSTEM AND METHOD OF SOLAR ENERGY COLLECTION

(71) Applicant: RELOAD FLOATING ENERGY, LLC, Boca Raton, FL (US)

(72) Inventors: Jason Harrison, Pompano Beach, FL (US); John Harrison, Pompano Beach, FL (US)

(21) Appl. No.: 17/145,631

(22) Filed: Jan. 11, 2021

Related U.S. Application Data
(60) Provisional application No. 62/959,272, filed on Jan. 10, 2020.

(51) Int. Cl. B63B 35/44; H02S 20/30; H02S 10/40; H02S 30/10

(52) U.S. Cl. CPC B63B 35/44; H02S 20/30; B63B 2231/50; H02S 30/10; B63B 2035/4453; H02S 10/40

(57) ABSTRACT

In general, the present invention is directed to floating solar photovoltaic platforms, which may include one or more high-density polyethylene resin encapsulating expanded polystyrene foam floats, one or more lift bars, and one or more module frames, wherein: the frames may support one or more solar photovoltaic modules, the platforms may be anchored by any number of means, and the position of the floats may be adjusted. In some embodiments, the floats may utilize a non-roto-rolled high-density polyethylene resin.

### CROSS-REFERENCE TO RELATED APPLICATIONS

The present application claims priority to U.S. Provisional Patent Application No. 62/959,272, filed on 10 Jan. 2020, entitled “Floatable Array Ready Solar Module Mounting Device, System, and Method of Solar Energy Collection,” there entirety of which is incorporated herein by reference.

### FIELD OF THE INVENTION

The invention broadly relates to Floating Solar Photovoltaic (FSPV) for floating solar panel modules in various individual, array, and system configurations. More particularly, the invention provides improvements, in manufacturing, transport, deploying, adjusting, maintaining and maximizing the solar collection and output of FSPV installations. The invention enables advantageous use of the Albedo effect for greater optimization, particularly when the system is used with bifacial Solar Photovoltaic (SPV) modules. It also enables quick connection/disconnection of FSPV components for various maintenance, assembly and configuration options.

### BACKGROUND

FSPV installations are nascent technological solutions that enable the scaling of solar generating capacity, particularly in regions with high population density and competing uses for available land. FSPV installations are advantageous over land-based systems, as FSPV are able to utilize existing electricity transmission infrastructure at hydropower sites, while providing improved energy production with proximity to demand centers (e.g. water reservoirs).

It is a general goal for FSPV installations that achieved performance advantages outweigh any increase in capital cost.

FSPV applications are less susceptible to shading of panels by surrounding land features. FSPV avoid the need for major site preparation, such as leveling or the laying of foundations done with conventional solar photovoltaic installations.

Amongst these and other advantages, adding FSPV installations to existing hydropower plants boosts the energy yield of such assets and enables continued energy production during periods of low water availability. Complementing each other, combining solar with hydropower enables smoothing variable output. Thus, FSPV enable a hydropower plant to operate in “peaking” rather than “baseload” mode and/or “load following mode,”’ and vice versa. FSPV installations particularly add value where energy grids are weak. FSPV installations also reduces evaporation from water reservoirs, as the FSPV installations provide shade and limit the evaporative effects of wind. This leads to improved water quality via decreased algae growth. At some hydropower plants, covering just 3-4% of the reservoir with FSPV doubles the installed capacity. There are dams on each continent that theoretically can accommodate hundreds of megawatts and/or gigawatts of FSPV installations.

FSPV arrays are mounted on floating platforms along with inverters. FSPV modules generate electricity that is collected by combiner boxes and converted to alternating current (AC) by the inverters. Additionally, invertors may be centrally located or strung on specially designed floating structures (PLATFORMS) and in some applications the inverters may be located on land. The PLATFORMS also often have integrated anchoring and mooring systems.

Most conventional FSPV arrays are deployed using pontoon-type PLATFORMS, with PV panels mounted at a fixed tilt angle. Typically, the PLATFORMS are made of “pure floats” or “floats” that are combined with metal trusses. A “pure float” configuration uses specially designed self-buoyant bodies to which PV panels are affixed. While another design uses metal structures to support PV panels in a manner similar to land-based systems. These metal structures are fixed to pontoons whose function is to provide buoyancy. Generally, PLATFORMS are held in place by an anchoring and mooring system, the design of which depends on factors such as wind load, float type, water depth, and variability in the water level. The PLATFORMS are generally air-filled roto-rolled interlocking floats, with small parts that are labor intensive to installed. When punctured or compromised the air-filled floats sink or lose their buoyancy.

There have been several recognized challenges to deployment of FSPV, including for example a lack of history/experience; uncertainty surrounding costs; uncertainty about predicting environmental impact; and the technical complexity of designing, building, and operating on and in water (especially electrical safety, anchoring and mooring issues, and operation and maintenance). For instance, marine and freshwater environments pose challenges for FSVP not present for land-based PV installation. These challenges include but are limited to: dynamic surface conditions involving waves and higher speed winds; tidal movements and currents that require mooring techniques; and the greater susceptibility of components to maintenance for water, salt and living organisms (“bio fouling”).

Alternative design and technological solutions and improvements are highly desired to improve the technology, improve its output, address these challenges and resolve and improve other unmet needs.

### SUMMARY OF THE INVENTION

The present invention broadly includes one or more floatation units (preferably at least two) spaced apart and spanned with an aluminum frame or other frame that attaches mechanically with the floats. This frame also accommodates the attachment of the solar panels and the pre-connected cable conduit system. The rear support legs of the hinging panel mount fold down allowing the solar panels to lay down flat within the frame to stack and nest multiple modules and efficiency in transportation. The frame system allows for a walkway along the top and sides of the module for ease of service and maintenance. The semi-rigid module-to-module connection system attaches consisting of two (2) fasteners and allows for flexing between modules. The frame design supports high-density polyethylene resin (HDPE) sheets horizontally to form a full and flush plane with the surface of the floatation. White color HDPE floats and sheets maximize the Albedo effect for use with bifacial solar panels. HDPE can be substituted with other suitable materials and/or reflective surfaces used. Also, disclosed is a mooring and anchoring method that enables easy adjustment of the panels depending on season, weather, time of day and other ad-hoc and climate conditions.

These and other aspects will become apparent from the following description of the invention taken in conjunction with the following drawings, although variations and modifications may be affected without departing from the scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary front perspective view of a device in accordance with some embodiments of the present invention;

FIG. 2 sets forth an exemplary rear perspective view of the device as shown in FIG. 1, in accordance with some embodiments of the present invention.

FIG. 3 sets forth an exemplary top perspective view of the device as shown in FIG. 1, in accordance with some embodiments of the present invention.

FIG. 4 illustrates an exemplary bottom perspective view of the device as shown in FIG. 1, in accordance with some embodiments of the present invention.

FIG. 5 illustrates an exemplary top plan view of the device as shown in FIG. 1, in accordance with some embodiments of the present invention.

FIG. 6 depicts an exemplary bottom plan view of the device as shown in FIG. 1, in accordance with some embodiments of the present invention.

FIG. 7 sets forth an exemplary front plan view of the device as shown in FIG. 1, in accordance with some embodiments of the present invention.

FIG. 8 depicts an exemplary rear plan view of the device as shown in FIG. 1, in accordance with some embodiments of the present invention.

FIG. 9 depicts an exemplary left side plan view of the device as shown in FIG. 1, in accordance with some embodiments of the present invention.

FIG. 10 illustrates an exemplary left side plan view of a device, in accordance with some embodiments of the present invention.

FIG. 11 illustrates an exemplary left side plan view of a device, in accordance with some embodiments of the present invention.

FIG. 12 illustrates an exemplary top perspective view of the device as shown in FIG. 1, in a floating environment in accordance with some embodiments of the present invention.

FIG. 13 illustrates an exemplary top perspective view of the device as shown in FIG. 1, in a floating environment and array configuration in accordance with some embodiments of the present invention.

FIG. 14 sets forth an exemplary bracketed front elevational view of the device as shown in FIG. 1, in accordance with some embodiments of the present invention.

FIG. 15 illustrates an exemplary bracketed right side elevational view of the device as shown in FIG. 1, in accordance with some embodiments of the present invention.

FIG. 16 illustrates an exemplary bracketed rear plan view of the device as shown in FIG. 1, in accordance with some embodiments of the present invention.

FIG. 17 sets forth an exemplary top elevational view of the device as shown in FIG. 1, in accordance with some embodiments of the present invention.

FIG. 18 illustrates an exemplary top elevational view of the device as shown in FIG. 1, in accordance with some embodiments of the present invention.

FIG. 19 sets forth an exemplary top elevational view of the device as shown in FIG. 1, in accordance with some embodiments of the present invention.

FIG. 20 illustrates an exemplary rear elevational view of the device as shown in FIG. 1, in accordance with some embodiments of the present invention.

FIG. 21 illustrates an exemplary downward facing solar module, in accordance with some embodiments of the present invention.

FIG. 22 illustrates an exemplary front plan view of an installed quick connection fastener of the device as shown in FIG. 1, in accordance with some embodiments of the present invention.

FIG. 23 illustrates a top plan view of a mooring system of the device as shown in FIG. 1, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

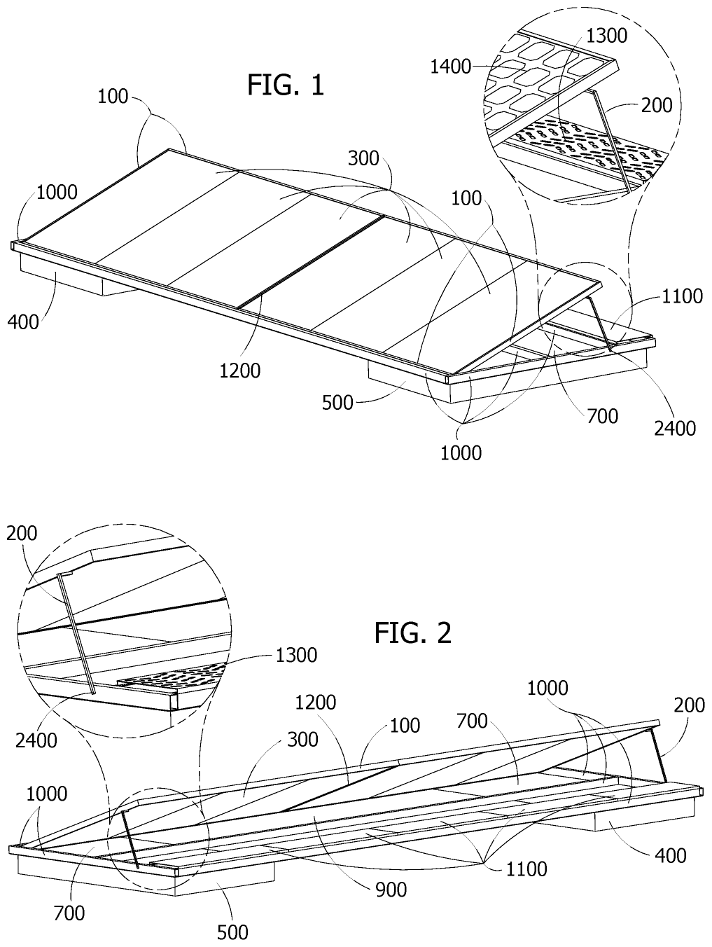

Referring now to the figures, FIG. 1 shows an exemplary front perspective view of the present invention. Components illustrated in FIG. 1 include: module frame 100; lift bar 200; solar module 300; left float 400; right float 500; float upper surface 700; primary frame 1000; front decking 1100; module frame brace 1200; deck grating 1300; solar cell 1400; and lift bar pivot 2400.

Note that sizing may vary greatly depending on configuration, use, specific solar panels selected, etc. Therefore, dimensions and sizes set forth herein reflect the sizing of a specific application of the invention, but in no way reflect a required—nor preferred sizing or configuration. For example, in accordance with some embodiments of the present invention, the complete unit may be approximately 96″×308″×16″ (e.g. 2.4 meters×7.8×0.4 meters). While this sizing can vary, this dimension may allow for the collapsed solar docks to be stacked on flatbed trailers approximately eight (8) high in two (2) rows, thereby potentially permitting approximately sixteen (16) 4 assembled units per truck.

The lift bar 200 may be a collapsible support arm. The lift bar 200 may be replaced by or used in conjunction with an a-frame support, hydraulic lift, air strut, cable, gears, chain and/or belt depending on the embodiment. In accordance with some embodiments (but in no way limiting) FSPV units may be eight (8) foot x twenty-four (24) foot sections (e.g. 2.5 meter×7.5 meter); each fitted with approximately six (6) vendor furnished panels. In general, each floating section may be comprised of two (2) or three (3) floats and fitted with an aluminum cross deck arranged to support large solar panels. Each floating section may be fitted with a longitudinal work deck for personnel access capable of interconnecting with adjacent floating sections and be designed for stacking. The work decks may be integrated into the floating section or attached separately. In some instances, side work decks going in a perpendicular direction may be desirable. Some embodiments may use approximately eight (8)×twenty-six (26) foot (e.g. 2 meter×8 meter) floating solar sections depending on the application and permitted dimensions for transport.

In some embodiments, each solar panel module may be capable of being hinged/pivoted prior to deployment so as to position the panels at a preset or indexed angle of inclination. The inclination angle may be fixed upon set up and manually lifted in place or by means of shore side equipment. The storage profile of the panels may be generally such that the units are stackable without loading of the solar panels from the stack loads. The solar panels are enabled to be grouped into several hinged panels based on their aggregate weight. The design and arrangement of the floating modules may be configured to permit the fit up of a reflective panel below the solar panels so as to provide bifacial absorption. In general, all surfaces are considerate of maximizing bi-facial refraction.

Additionally, in some and other embodiments, the overall construction of the modules may be of aluminum profiles and welded sections (though other materials may be utilized). It may be desirable to use readably available hardware for maintenance, cost and ease of assembly. In addition to the transport and shipping loads, additional considerations are given towards the lifting of the modules, and environmental loading.

It may be generally intended that the solar arrays/fields are installed on closed bodies of water, generally not subject to vessel traffic or similar means of wake generation and that the sea conditions may be limited to a very light wind induced chop. Similarly, wind loads may include hurricane force winds up to a specified velocity, but enabling adjustment of the panels to the stowed position may protect against potential wind damage.

Again, while sizing may vary depending on application and configuration, in accordance with some embodiments of the present invention framing dimensions when using aluminum and similar materials range from approximately two (2)×three (3) inches through two (2)×five (5) inches (5 cm×7.5-13 cm) and that U-channels are 1″×1.25″ and 1.5″×3″ (2.5-4 cm×3-8 cm). The floats made of HDPE may be approximately 5′×8′×4″ through 5′×8′×8″ (e.g. 1.5 m×2.5 m×10-21 cm). In some cases, these dimensions may provide particular transportation, deployment and shipping benefits. However, actual dimensions may vary significantly from these ranges depending on the embodiment and requirements for the installation.

FIG. 2 is a rear perspective view of the invention shown in FIG. 1. In FIG. 2 are shown and numerically labeled: module frame 100; lift bar 200; solar module 300; left float 400; right float 500; float upper surface 700; primary frame 1000; front decking 1100; module frame brace 1200; deck grating 1300; and lift bar pivot 2400. The decking grate may provide grip, drainage, and light transmission. In accordance with some embodiments of the invention, decking grate may provide 60% light transmission. In accordance with some embodiments of the present invention, decking may be solid and highly reflective and/or white. Greater light transmission in the decking may enables growth of sea grass, plants and other life that depend on solar light. It may also enables heating and evaporation of water underneath the decks.

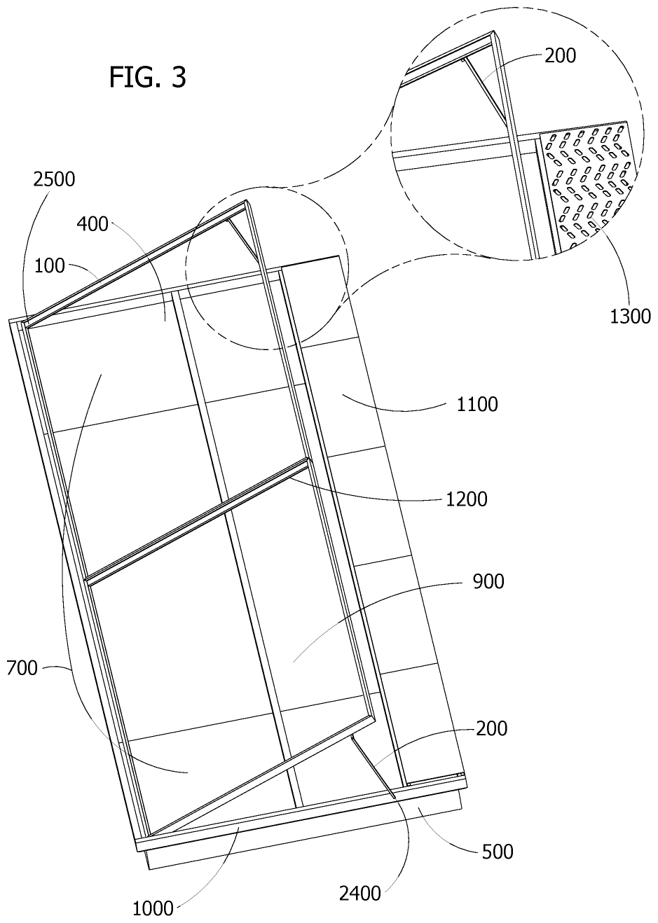

FIG. 3 is a top perspective view of the invention shown in FIG. 1. In FIG. 3 are shown and numerically labeled: module frame 100; lift bar 200; left float 400; right float 500; float upper surface 700; primary frame 1000; front decking 1100; module frame brace 1200; deck grating 1300; and lift bar pivot 2400.

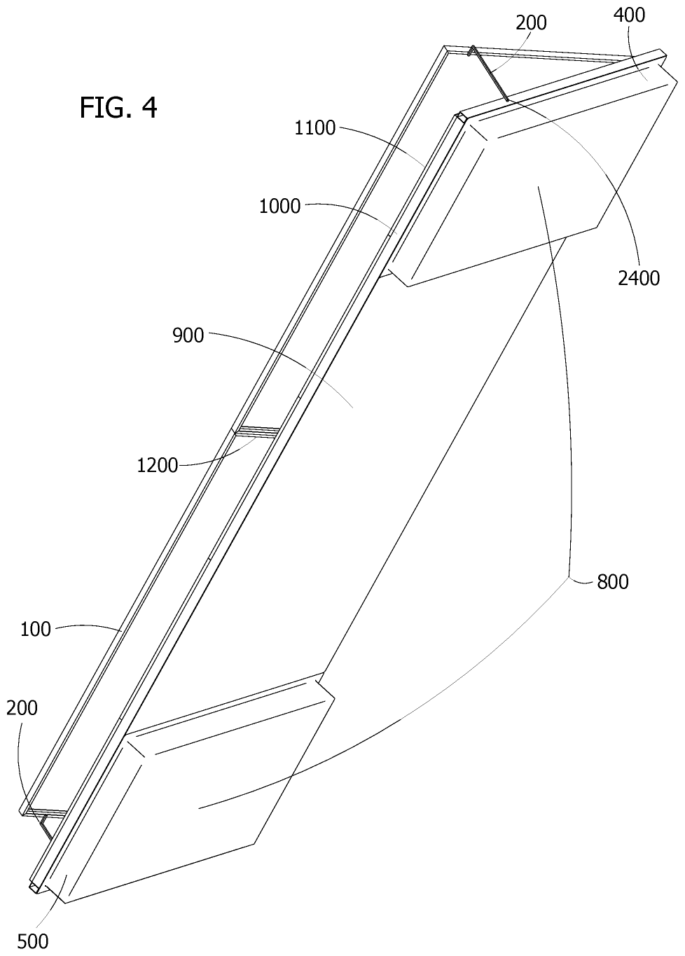

FIG. 4 is a bottom perspective view of the invention shown in FIG. 1. In FIG. 4 are shown and numerically labeled: module frame 100; lift bar 200; left float 400; right float 500; float lower surface 800; reflective white polyethylene 900; primary frame 1000; front decking 1100; module frame brace 1200; and lift bar pivot 2400.

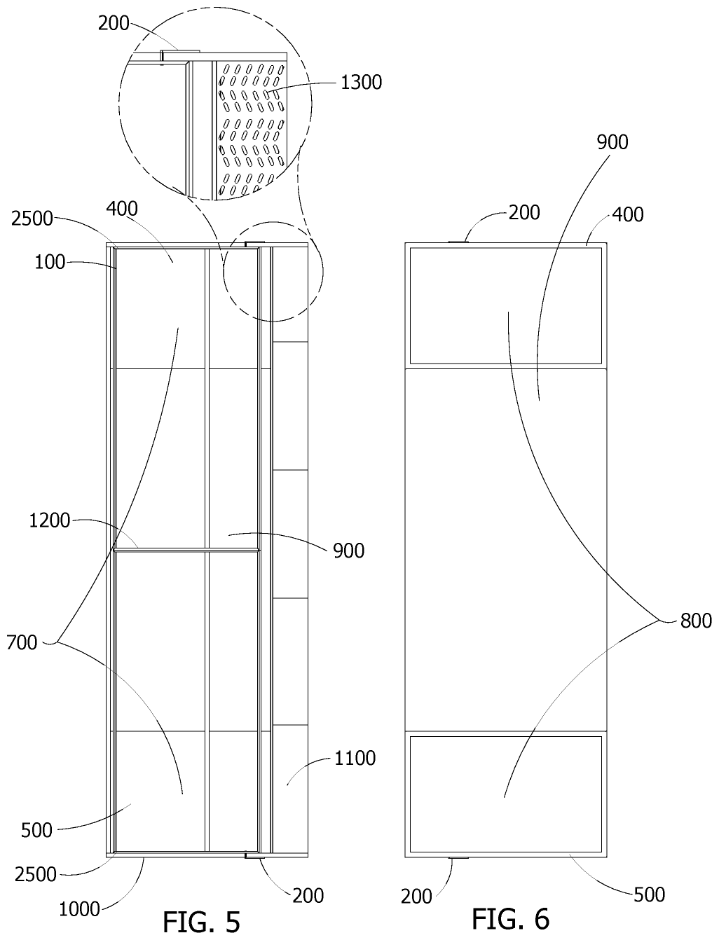

FIG. 5 is a top plan view of the invention shown in FIG. 1. In FIG. 5 are shown and numerically labeled: module frame 100; lift bar 200; left float 400; right float 500; float upper surface 700; reflective white polyethylene 900; primary frame 1000; front decking 1100; module frame brace 1200; and lift bar pivot 2400.

FIG. 6 is a bottom plan view of the invention shown in FIG. 1. In FIG. 6 are shown and numerically labeled: module frame 100; lift bar 200; left float 400; right float 500; float lower surface 800; reflective white polyethylene 900; primary frame 1000; front decking 1100; module frame brace 1200; deck grating 1300; lift bar pivot 2400; and solar module frame pivot 2500.

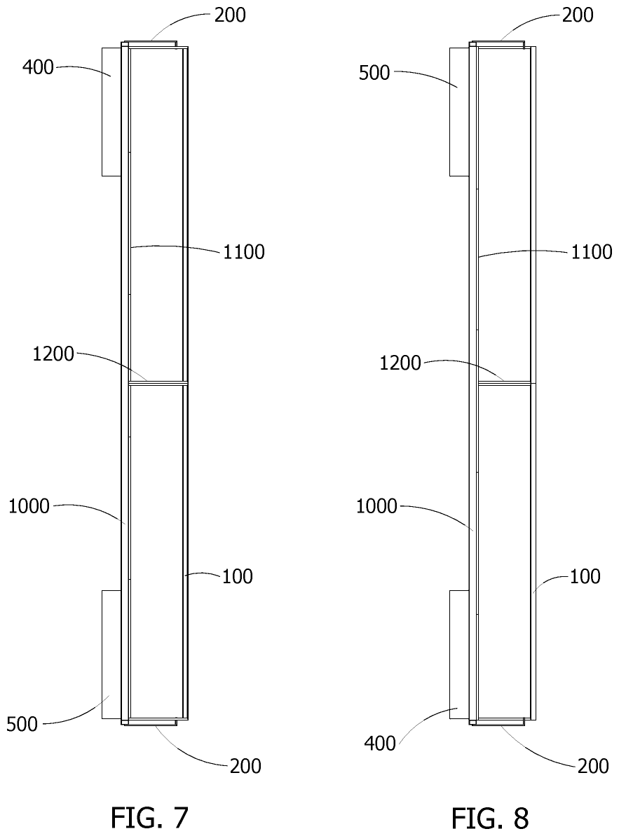

FIG. 7 is a front plan view of the invention of FIG. 1. In FIG. 7 are shown and numerically labeled: module frame 100; lift bar 200; left float 400; right float 500; primary frame 1000; front decking 1100; and module frame brace 1200.

FIG. 8 is a rear plan view of the invention of FIG. 1. In FIG. 8 are shown and numerically labeled: module frame 100; lift bar 200; left float 400; right float 500; primary frame 1000; front decking 1100; and module frame brace 1200.

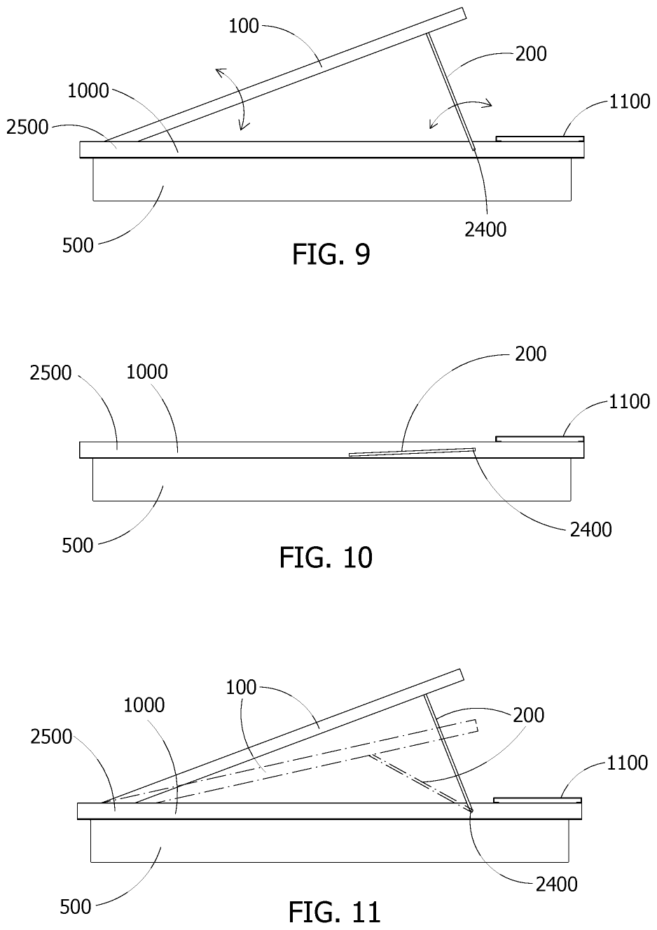

FIG. 9 is a left side plan view of one configuration the intention of FIG. 1. In FIG. 9 are shown and numerically labeled: module frame 100; lift bar 200; right float 500; primary frame 1000; front decking 1100; lift bar pivot 2400; and solar module frame pivot 2500.

FIG. 10 is a left side plan view of one configuration the intention of FIG. 1. In FIG. 10 are shown and numerically labeled: lift bar 200; right float 500; primary frame 1000; front decking 1100; lift bar pivot 2400; and solar module frame pivot 2500.

FIG. 11 is a left side plan view of one configuration the intention of FIG. 1. In FIG. 11 are shown and numerically labeled: module frame 100; lift bar 200; right float 500; primary frame 1000; front decking 1100; lift bar pivot 2400; and solar module frame pivot 2500.

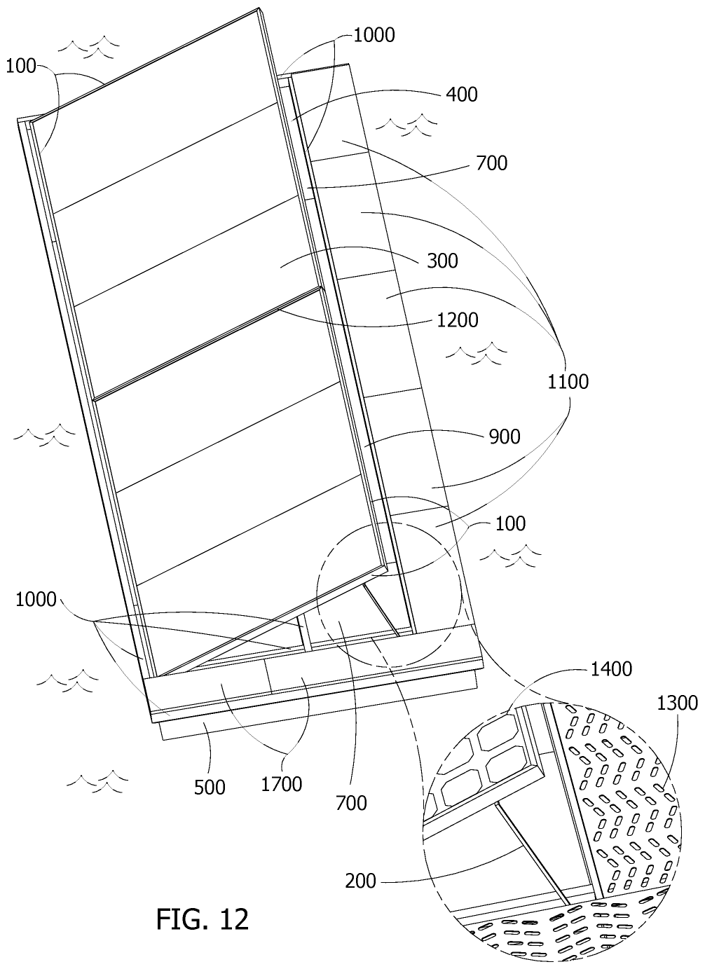

FIG. 12 is a top perspective view of the invention shown in FIG. 1 in a floating environment. In FIG. 12 are shown and numerically labeled: module frame 100; lift bar 200; solar module 300; left float 400; right float 500; float upper surface 700; primary frame 1000; front decking 1100; module frame brace 1200; deck grating 1300; solar cell 1400; 1700 side decking; and lift bar pivot 2400.

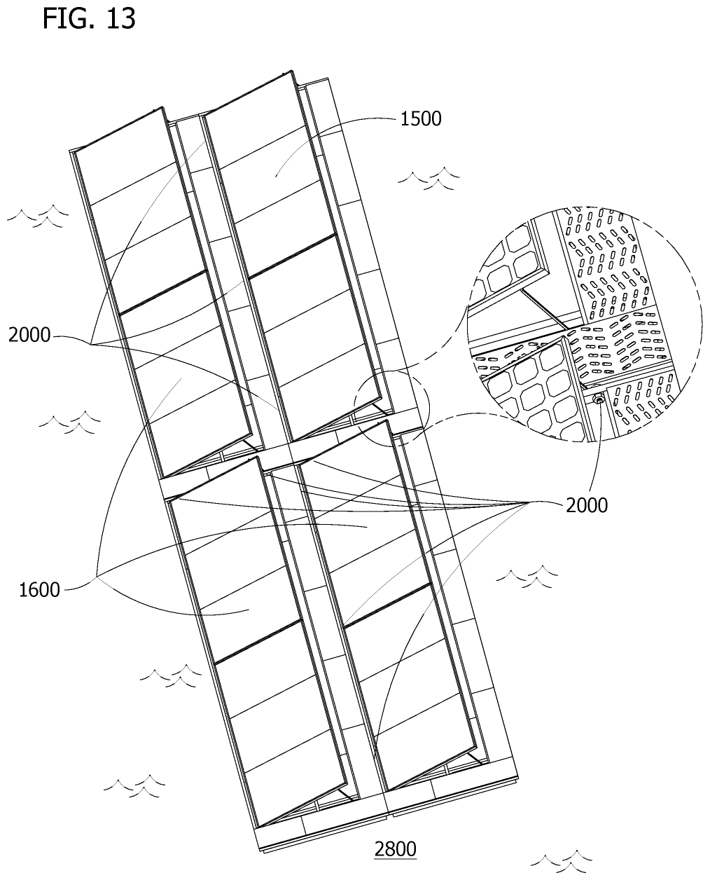

FIG. 13 is a top perspective view of the invention shown in FIG. 1 in a floating environment. In FIG. 13 are shown and numerically labeled: main float dock 1500; attached float dock 1600; and multi dock fastener assembly 2000.

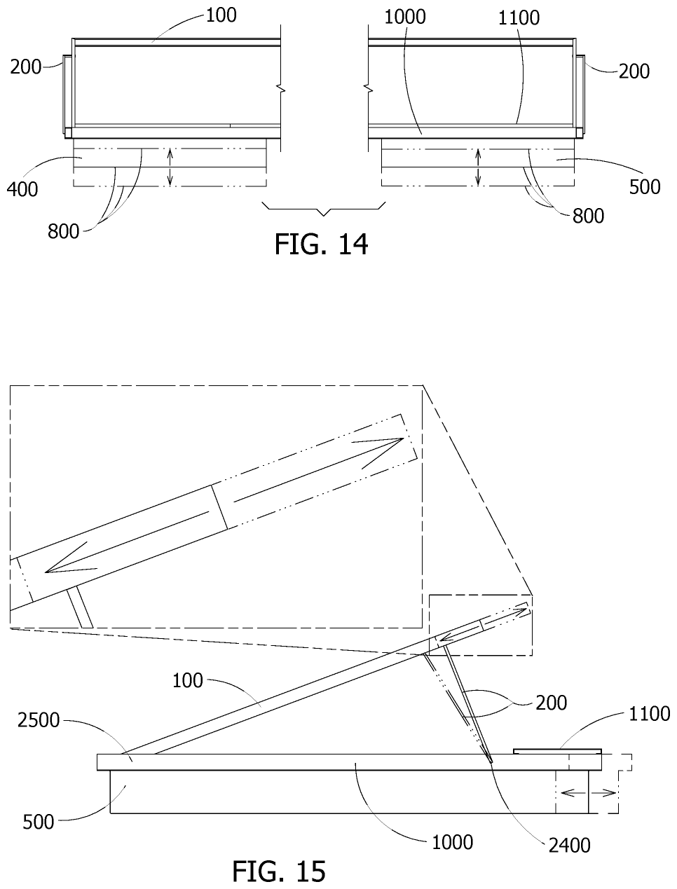

FIG. 14 is a bracketed front elevational view of the invention shown in FIG. 1. In FIG. 14 are shown and numerically labeled: module frame 100; lift bar 200; left float 400; right float 500; float lower surface 800; primary frame 1000; and front decking 1100.

FIG. 15 is a bracketed right side elevational view of the invention shown in FIG. 1. In FIG. 15 are shown and numerically labeled: module frame 100; lift bar 200; right float 500; primary frame 1000; front decking 1100; lift bar pivot 2400; and solar module frame pivot 2500.

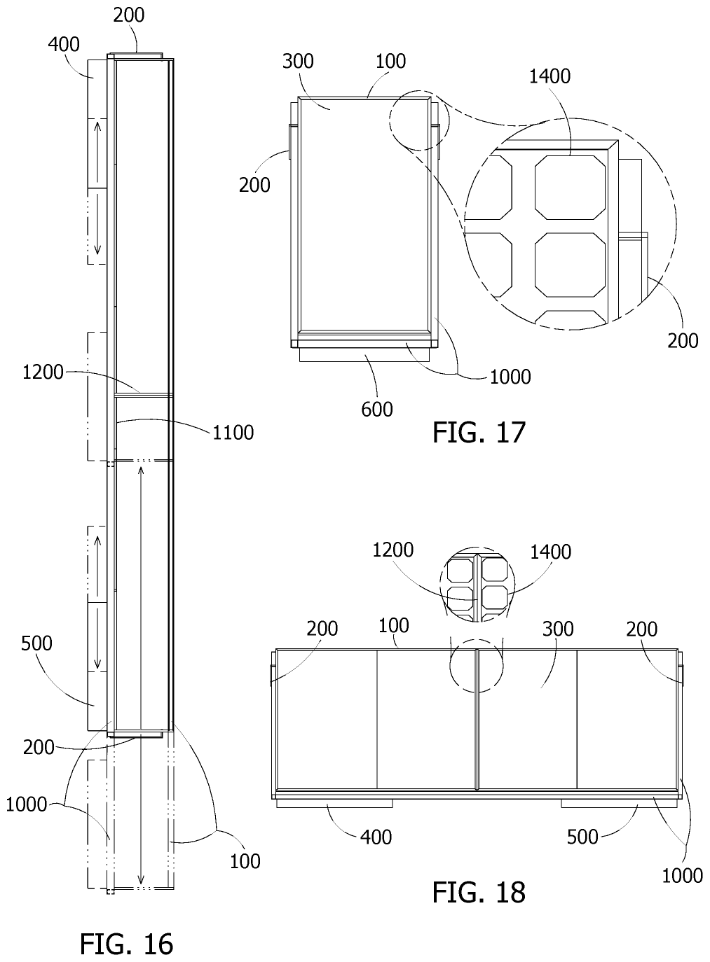

FIG. 16 is a bracketed rear elevational view of the invention shown in FIG. 1. In FIG. 16 are shown and numerically labeled: module frame 100; lift bar 200; left float 500; right float 500; primary frame 1000; front decking 1100; and module frame brace 1200.

FIG. 17 is a top elevational view of the invention shown in FIG. 1. In FIG. 17 are shown and numerically labeled: module frame 100; lift bar 200; solar module 300; primary frame 1000; float 600; primary frame 1000; and solar cell 1400.

FIG. 18 is a top elevational view of the invention shown in FIG. 1. In FIG. 18 are shown and numerically labeled: module frame 100; lift bar 200; solar module 300; left float 400; right float 500; primary frame 1000; module frame brace 1200, and solar cell 1400.

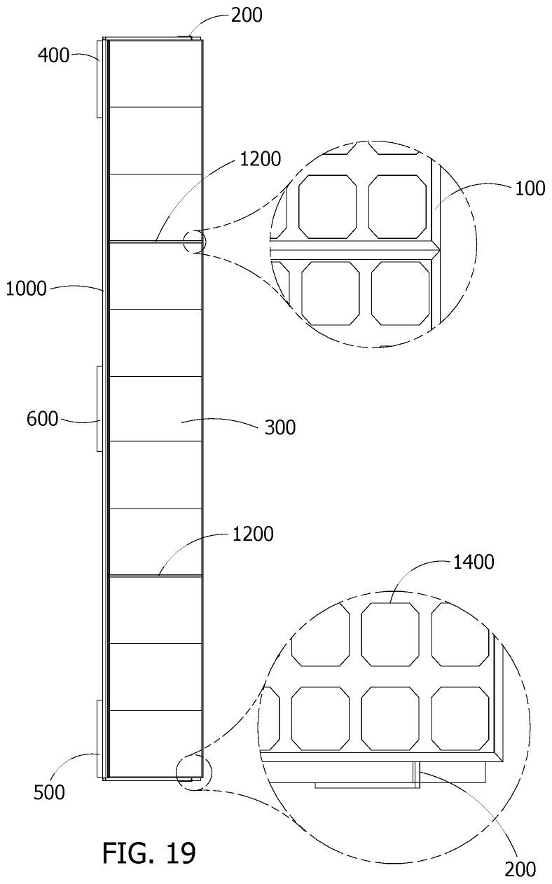

FIG. 19 is a top elevational view of the invention shown in FIG. 1. In FIG. 19 are shown and numerically labeled: module frame 100; lift bar 200; solar module 300; left float 400; right float 500; float 600; primary frame 1000; module frame brace 1200, and solar cell 1400.

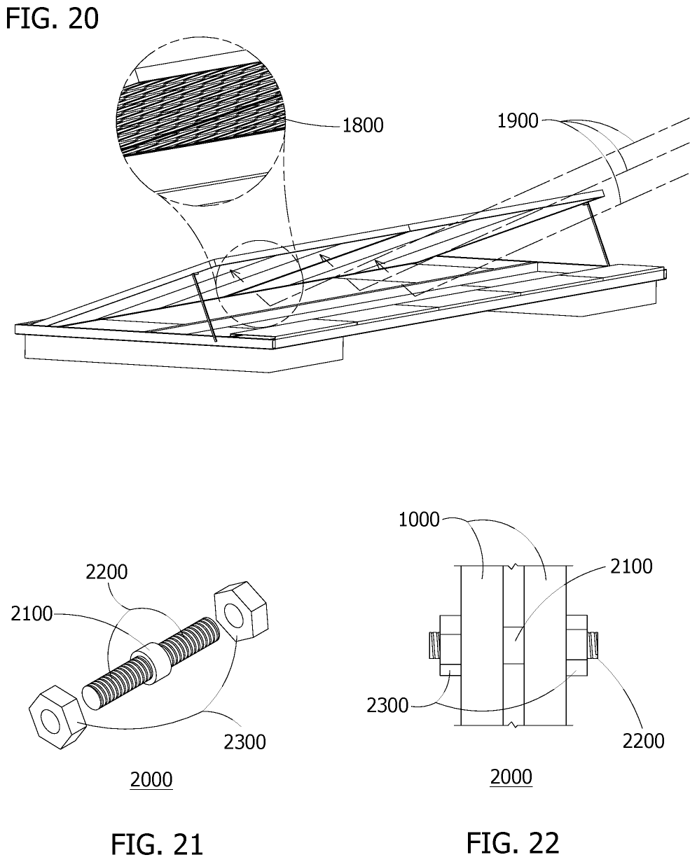

FIG. 20 is a rear elevational view of the invention shown in FIG. 1 illustrating a downward facing solar module from a bifacial installation. In FIG. 20 are shown and numerically labeled: bottom facing solar cell 1800; and solar rays 1900. Bifacial modules may produce solar power from both sides of the panel. Bifacial modules expose both the front and backside of the solar cells.

FIG. 21 is an elevational view of the quick connection fastener of the invention shown in FIG. 1. In FIG. 21 are shown and numerically labeled: multi dock fastener assembly 2000; elastic spacer 2100; all-thread 2200; and nut 2300.

FIG. 22 is a front plan view of an installed quick connection fastener of the invention shown in FIG. 1. In FIG. 22 are shown and numerically labeled: primary frame 1000; multi dock fastener assembly 2000; elastic spacer 2100; all-thread 2200; and nut 2300.

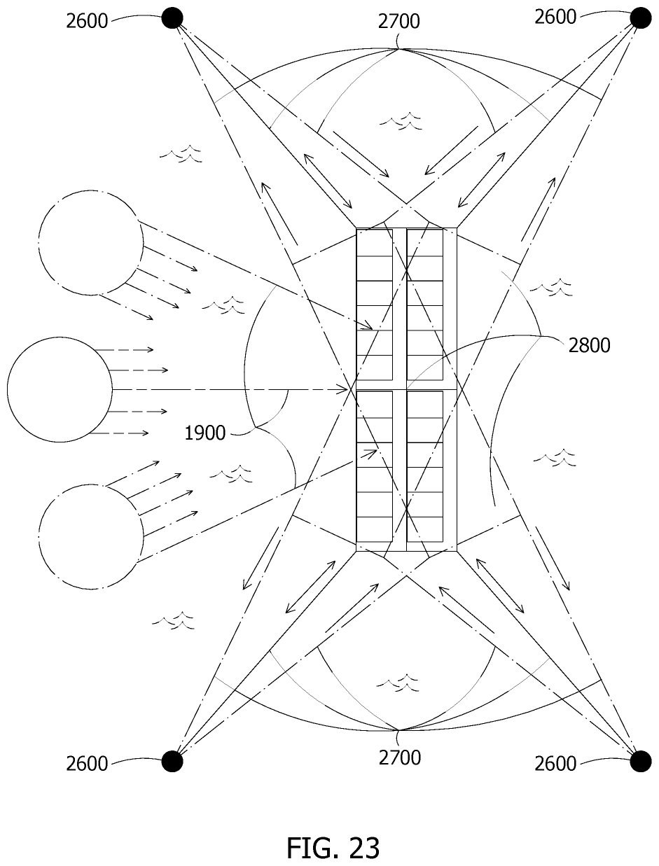

FIG. 23 is a top plan view of a mooring system for the invention shown in FIG. 1. In FIG. 22 are shown and numerically labeled: solar rays 1900; moor anchor point 2600; anchor line 2700; and float dock array 2800. The moor anchor lines 2700 may be tightened and/or loosened to adjust the direction of the solar arrays. Attachment methods may include any or all of the following, as well as custom brackets not mentioned: Anchoring to pilings, seawalls, bulkheads, existing floating docks, spud poles, cross anchoring underneath dock, anchor chains, eco-mooring rodes with helix anchors, gangway hinge points, control arm hinges, and/or standoffs.

Although dimensions vary by application, in accordance with some embodiments of the present invention the left float 400, right float 500 and other float 600 may generally have a minimum wall thickness of 0.150 inches, and may generally encapsulate expanded polystyrene (EPS) foam. In accordance with some embodiments, the lid or top surface may have a lip around the entire float; in some embodiments this lip may measure approximately 2.5″. HDPE plastic may be white in color, and may generally be provided with a levant non-skid texture. Such material may incorporate an ultraviolet inhibitor, in accordance with some embodiments of UV-8 or better.

Moreover, while not a required part of the invention, plastic material may meet requirements of ASTM D4976-PE 235 & FDA 21CFR 177.1520. A recommended density of a section for common applications is equal to approximately 0.950 grams per cubic inch or 0.058 grams per cubic centimeter per ASTM D4883. In many applications, the tensile strength at yield may vary, but in some embodiments may be greater than 3800 pounds per square inch, and at break greater than 4400 pounds per square inch, per ASTM D638.

Materials used may have a cold brittleness temperature at no less than −103° F. Encapsulated Expanded Polystyrene (EPS) should be of a closed cell nature allowing no more than 3% water penetration. In some embodiments, each left float 400, right float 500 and other float 600 may have a maximum weight of no more than 120 pounds, and draft no more than 1″ under dead load.

It will be understood that the specific embodiments of the present invention shown and described herein are exemplary only. Numerous variations, changes, substitutions, and equivalents will now occur to those skilled in the art without departing from the spirit and scope of the invention. Accordingly, it is intended that all subject matter described herein and shown in the accompanying drawings be regarded as illustrative only, and not in a limiting sense.

What we claim is:

1. A floating solar photovoltaic platform, comprising:
one or more floats;
a primary frame;
a module frame;
wherein the floats comprise high-density polyethylene resin encapsulating expanded polystyrene foam.

2. A floating solar photovoltaic platform system, comprising:
one or more high-density polyethylene resin encapsulating expanded polystyrene foam floats;
one or more lift bars; and
one or more module frames;
wherein:
the one or more module frames supports one or more solar photovoltaic modules;
the one or more of the floats utilize one or more of a white or reflective material;
one or more of the platforms is anchored using at least one or more mooring lines attached to at least one or more anchor points comprising pilings, seawalls, bulkheads, existing floating docks, spud poles, cross anchoring underneath dock, anchor chains, eco-mooring rods with helix anchors, gangway hinge points, control arm hinges, and standoffs; and
the length of the one or more mooring lines between the platform and the one or more anchor points is adjusted to change a position of the floating solar installation.

3. A system of floating solar photovoltaic installations, comprising:
an array of platforms connectively associated with each other, each platform comprising at least:
one or more non-roto-rolled high-density polyethylene resin encapsulating expanded polystyrene foam floats;
a primary frame a module frame;
a lift bar; and
a solar photovoltaic module;
wherein the array is anchored to two or more anchor points by mooring lines and a position of the array is adjustable by tightening or loosening the mooring line between one or more of the platforms and one or more of the anchor points.
